(19) United States
(12) Patent Application Publication
(10) Pub. No.: US 2023/0298051 A1
(43) Pub. Date: Sep. 21, 2023

(54) PERSONALIZED REPORTING SERVICE

(71) Applicant: INTUIT INC., Mountain View, CA (US)

(72) Inventors: Aviv BEN ARIE, Ramat Gan (IL); Yair HORESH, Kfar-Saba (IL)

(21) Appl. No.: 17/700,223

(22) Filed: Mar. 21, 2022

(51) Int. Cl. G06Q 30/02

(52) U.S. Cl. CPC G06Q 30/0201

(57) ABSTRACT

Certain aspects of the present disclosure provide techniques for a personalized reporting service. Software applications can provide relevant reports that aggregate time series data to users that meet certain baseline values, including a threshold, timeframe, and cadence. The baseline values can be determined by a trained machine-learning model that identifies “interesting” trend components in the time series data. The reporting service can receive configurations from the user including feedback that are utilized by the machine-learning model to update the baseline values and provide relevant reports to the user.

### INTRODUCTION

Aspects of the present disclosure relate to a personalized reporting service in software applications.

### BACKGROUND

Users often implement software program products to assist in the management of data. One feature of software program products is the reporting of data which may provide insight into the user, such as trends in the user's data, may be used for various projections of the user's future state, and provide other useful information to the user. In order to report data to the user, the software program product can generate multiple types of reports for the user to review, analyze, and/or consider based on the data managed by the software program product.

However, in order to view these reports, users may be required to manually select these reports for generation within the software application. In such instances, the user may not understand what each report means or how a report is actually relevant to the user. As a result, the user may not select a report that would otherwise be relevant to the user or may select reports that are actually irrelevant to the user. Further, manual selection of reports to be generated by the software program product can be time-consuming and can result in redundant reports being generated. In other instances, the reporting service can provide each report to the user (e.g., according to a defined schedule, based on the occurrence or non-occurrence of defined events, etc.). In such cases, the user may not understand what each report means, or the report may not be relevant or may have limited relevance to the user. For example, a user may receive ten reports from the software program product but only utilize five of the ten reports because the other reports are too technical or “detached” from the current state of the user. Thus, regardless of whether reports are generated manually or automatically, computing resources (e.g., processor time, memory, etc.) used to generate these reports may be wasted.

Therefore, a solution is needed that provides improvements over conventional reporting features in software program products.

### SUMMARY

Certain embodiments provide a method, for example, to provide personalized reporting. The method includes generating via a reporting service of a software application a set of reports corresponding to a software program product, wherein the set of reports corresponds to a first period of time and each report in the set of reports includes a set of components. The method further includes determining for the set of reports: a baseline threshold for each component in the set of components, a baseline reporting timeframe, and a baseline reporting cadence. The method further includes generating a first subset of reports corresponding to the baseline reporting timeframe by identifying each report in the set of reports that meets the baseline threshold. The method further includes providing the first subset of reports to a user at the baseline reporting cadence. The method further includes receiving a set of configurations and feedback from the user of the software application. The method further includes updating the baseline threshold for each component in the set of components, the baseline reporting timeframe, and the baseline reporting cadence according to the set of configurations and feedback from the user. The method further includes generating a second subset of reports from the first subset of reports corresponding to the updated baseline reporting timeframe by identifying each report in the set of reports that meets the updated baseline threshold, wherein the second subset of the reports corresponds to a second period of time. The method further includes providing the second subset of reports via the reporting service to the user at the updated baseline reporting cadence.

Other embodiments provide a method, for example, for personalizing reporting. The method includes receiving at a first time a set of reports regarding time series data corresponding to the first time via a software application. The method further includes displaying the set of reports to a user of the software application via an interactive user interface. The method further includes receiving a configuration and feedback from the user via the interactive user interface indicating a subset of reports from the set of reports. The method further includes providing the configuration and feedback to the software application. The method further includes receiving at a second time the subset of reports corresponding to the configuration from the user. The method further includes displaying the subset of reports to the user.

Other embodiments provide systems to perform aforementioned methods associated with personalized reporting services of a software program product. Additionally, other embodiments provide non-transitory computer-readable storage mediums comprising instructions for performing the aforementioned methods.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 depicts an example computing environment implementing a reporting service, according to an embodiment.

FIG. 2 depicts an example flow diagram of implementing the reporting service, according to an embodiment.

FIG. 3 depicts an example interactive user interface, according to an embodiment.

FIG. 4 depicts an example method of providing personalized reporting, according to an embodiment.

FIG. 5 depicts an example processing system, according to an embodiment.

FIG. 6 depicts an example method of personalizing reporting, according to an embodiment.

FIG. 7 depicts another example computing device, according to an embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In many software program products, reports which summarize various metrics may be generated. These software program products may include a broad universe of reports; however, because of the size of this universe of reports, users may not understand what each report means or misunderstand the relevance of a report, and thus, the user may omit the generation of reports that are useful and generate reports that may not be relevant. In some cases, these software program products may automatically generate reports for the user, which may provide for the generation of reports without the user manually selecting the reports to be generated and thus either including irrelevant reports or omitting relevant reports from a set of generated reports. However, in automatically generating these reports (e.g., according to a defined time schedule), a user may not be able to differentiate between reports including data of interest and reports that do not show significant changes relative to previously generated reports. Thus, automatically generating these reports may also waste compute resources by generating reports that are not relevant to the user.

Aspects of the present disclosure provide techniques for generating reports in a software program product via a personalized reporting service that generates reports that are likely to be relevant to the user of the software program product and omit the generation of reports that are less likely to be relevant to the user of the software program product. As discussed in further detail herein, a software program product can generate an initial set of reports corresponding to, for example, time series data for each respective report in the initial set of reports. The initial set of reports may include each report the software program product is capable of generating (e.g., based on templates).

Once the initial set of reports is generated, baseline values can be determined for the set of reports that corresponds to a baseline threshold, reporting timeframe, and reporting cadence. The baseline threshold refers to whether or not a report meets a threshold value indicating the report can be of interest or relevance to a user, such as any trend, sudden changes, or directional changes in the time series data of the report. The reporting timeframe refers to the period of time the time series data of a report covers. The reporting cadence refers to how often the report is generated. The initial baseline values can be generated based on a trained model (e.g., a supervised machine-learning model like support-vector model, logistic regression model, random forest, etc.) or set by an administrator associated with the software program product. For example, if there is data available, such as from testing, then a supervised machine-learning model can be trained on the testing data that can include test user configurations and feedback regarding generated reports. In other cases, where there is no testing data available, then an administrator may set the initial baseline values. The feedback received from a user, as well as the initial baseline values, can then be used as training data to train a model. Once there is feedback from the user, then the baseline values can be adjusted and generated by the model to subsequently control the automatic generation of relevant reports for the user of the software program product.

A subset of reports can then be identified from the initial set of reports by determining which reports in the initial set of reports meets the baseline threshold value. The subset of reports may be provided to the user, for example, according to the baseline values corresponding to the reporting timeframe and cadence.

Upon receiving the subset of reports, the user can provide configuration data (or user configurations), which can include user selections, that can indicate which report of the subset of reports is of interest, relevance, value, etc. to the user. By selecting the report(s), the user can customize the reporting of a software program product. As a result, the user is able to receive reports that the software program products indicates are relevant based on meeting certain baseline values, as well as reports the user is interested in reviewing. Reports that are not selected by the user can be blocked from being provided to the user. In some cases, such reports can subsequently be provided to users despite the user's selection of reports based on changes in underlying data (e.g., time series data corresponding to a later period of time).

In addition to receiving user selections regarding the subset of reports, the personalized reporting service can also receive feedback from the user regarding the subset of reports. The feedback can be binary (e.g., “like” or “dislike”, “helpful” or “not helpful”, etc.). The feedback can also be text data to which natural language processing algorithms are applied to determine what the user liked or did not like about the report as well as any issues that need to be addressed regarding the report (e.g., formatting).

By implementing a personalized reporting service that generates reports based on baseline values that are continually adjusted using a trained model, a software program product can prevent redundant or wasted usage of computing resources because the reports provided are relevant and/or of interest to the user and unnecessary reports are not being generated. The prevention of wasted computing resources can also result in an efficient and effective use of computing resources. Additionally, by providing reports of interest to the user as well as utilizing user feedback, the personalized reporting service can enhance the user experience of the software program product. Still further, because the baseline values used to trigger generation of these reports may be automatically and progressively refined, aspects of the present disclosure may allow for the continual refinement of triggering conditions for generating reports to further improve the relevance and timeliness of these generated reports.

### Example Computing Environment

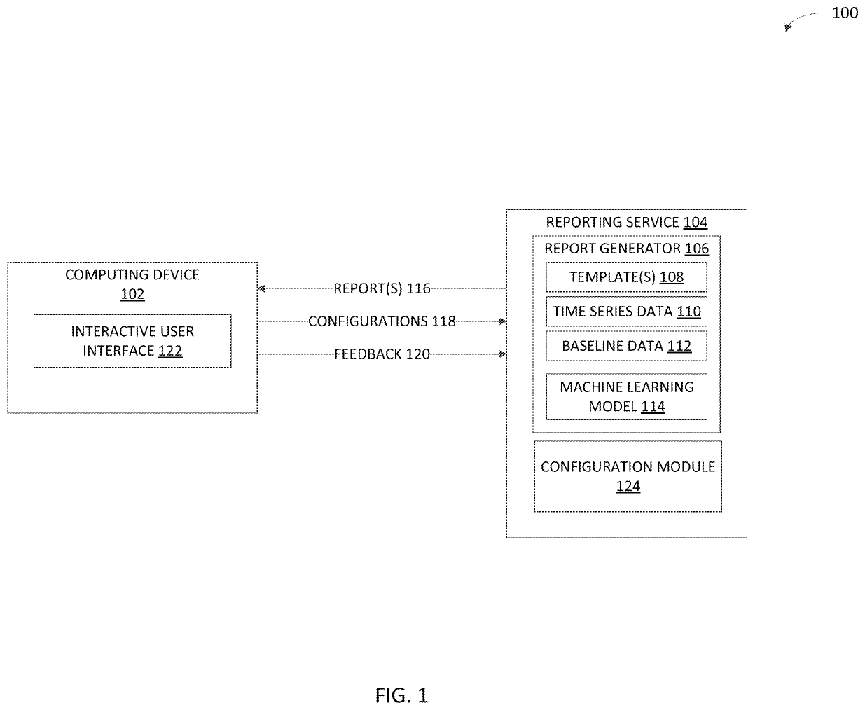

FIG. 1 depicts an example computing environment 100 implementing a reporting service for a software program product.

As illustrated, computing environment 100 includes a computing device 102 and a reporting service 104. The computing device 102 can include a tablet, laptop, smartphone, and other devices with similar capabilities. The computing device 102 can interact with a reporting service 104 of a software program product. In some cases, an instance of the software program product with the reporting service 104 can be installed on the computing device 102. In other cases, the software program product with the reporting service 104 is located remotely on a server (e.g., physical or virtual) that the computing device 102 interacts with. For example, the computing device 102 can access the reporting service 104 of the software program product via a web browser.

The reporting service 104 of the software program product can generate reports for the user based on data from the software program product. For example, if the software program product is a financial application, the reporting service can prepare reports for the user regarding financial data of the user such as income, profits, losses, etc. If the software program product is a medical application, the reporting service can prepare reports for the user regarding medical data of the user such as heart rate, blood sugar, temperature, etc.

In order for the reporting service 104 to generate relevant and useful reports for the user, the reporting service 104 utilizes a report generator 106 and configuration module 124. The report generator 106 of the reporting service 104 initially generates each report available of the reporting service 104. The initial reports that are generated are based on all of the available report templates 108 in the software application. A report is generated by the report generator 106 populating the template 108 with an aggregation of time series data 110 of a period of time regarding a specific data value. For example, a profit report can be an aggregation of time series data corresponding to profit and a profit report template. Additionally, each report can include a set of components. A component is an indicator of a time series data pattern. For example, a component can include whether there is a trend in the time series data, whether there is a sudden change in the time series data, or whether there is a directional change of the time series data.

Once each report of the reporting service is generated, a set of baseline data 112 are determined. For example, a baseline data value can indicate a threshold for generating the report. The baseline threshold values generally include a set of components that are indicative of time series data patterns that may be of interest to the user. For example, these time series data patterns may comprise trends in the time series data (e.g., a trend, over time, for the underlying data to increase in value, decrease in value, remain range-bound between an upper bound and a lower bound, etc.), whether there is a sudden change in the time series data, or whether there is a directional change of the time series data.

The baseline data 112 can be determined by a machine learning model 114. For example, a machine learning model 114 can be trained based on previously generated reports that are identified (or labeled) corresponding to a component (e.g., trend, sudden change, or directional change). One example is a Seasonal and Trend (STL) decomposition algorithm for identifying the components. Other algorithms can be applied that can identify the components in the data.

In some cases, the baseline data can initially be set by an administrator of the software program product. Additional baseline values can include a baseline reporting cadence and a baseline timeframe. The baseline reporting cadence is the rate at which the report is generated. The baseline timeframe is a period of time the corresponding time series data is aggregated.

Once the initial set of reports is generated, the report generator 106 can apply the baseline data 112 (or “baseline values”) to determine which of the reports generated meet the baseline values. For example, if the software program product is capable of generating 100 reports, then the baseline threshold value is applied to the each of these 100 reports to identify which reports meet the baseline threshold—specifically, which reports have components indicative of time series data patterns that could be of interest to the user. The reports 116 that are identified as meeting the baseline threshold value are provided to the user as a subset of reports at a baseline cadence covering a baseline timeframe.

Upon receiving the subset of reports 116, the user can provide configurations 118 and feedback 120 as to whether the user found the reports in the subset of reports to be relevant, useful, or if there were any issues with the report such as formatting issues that the reporting service 104 should address. In some cases, the configurations 118 can include the user indicating which reports in the subset of reports the user wants to continue see or does not want to see. The configurations 118 can be provided from the user to the computing device 102 via an interactive user interface 122 that allows the user to not only indicate what reports 116 the user would like to receive going forward but is also where users can provide feedback 120 regarding the report 116. The feedback 120 can indicate what the use found to be useful or relevant about a report, what the user would like to see in the report (e.g., an increased timeframe), how often the user would like to receive the report (e.g., cadence of the reporting), what format of the user would like to receive the report (e.g., email, PDF, etc.), if there are any issues with the presentation of data (e.g., formatting difficult to read due to layout, font, etc.) within the report, etc. With the configurations 118 and feedback 120, each user is able to personalize the data reporting in a manner that the user so chooses.

The configurations 118 and feedback 120 are generally received by the configuration module 124 of the reporting service 104. The configuration module 124 can provide the configurations 118 and feedback 120 to the report generator 106 to update the update how the subset of reports is generated and the baseline data 112. For example, if the configuration 118 include user indication to receive a report daily instead of weekly, the reporting cadence for the user is updated in the baseline data 112. As another example, if a user indicates that they do not want to see a report in the subset of reports, then the configuration module 124 can provide the indication to the report generator 106 and in future instances of reporting, the report that the user did not want to see will not be included (e.g., blocked) in the subset of reports 116. In another example, if the user indicates there is a formatting issue with a report in the feedback 120 then the configuration module 124 can notify and/or provide a solution to correct the formatting issue to the report generator 106. In some cases, the configuration module 124 can analyze the feedback received by applying natural language processing algorithms.

In some aspects, the user can provide configurations 118 and feedback 120 via a survey presented to the user. The survey may allow a user to provide data at varying levels of granularity for each report indicating whether the user found the reports in the subset of reports to be relevant, useful, or if there were any issues with the report. For example, the survey may allow a user to indicate relevance or usefulness as a binary choice (e.g., “useful” or “not useful”, “relevant” or “not relevant”, etc.) or as a score on a defined scale.

In some aspects, the survey may also or alternatively allow a user to provide feedback about the reports in the subset of reports as natural language feedback. To determine whether the natural language feedback indicates that a report was useful or not useful, for example, sentiment analysis techniques may be used to determine whether the natural language feedback is positive (corresponding to a useful report) or negative (corresponding to a report deemed not useful). Other natural language analyses can be used to identify feedback that can be used to personalize the data reporting. For example, natural language processing models can be used to identify, for example, phrases indicating a desired periodicity at which the reports are to be generated, a desired format in which the reports are to be delivered, a desired amount of information in a report, or the like. Phrasing indicating changes to the periodicity at which reports are to be generated may, for example, trigger a model to adjust one or more baseline values or a baseline reporting cadence. Similarly, phrasing indicating changes to the desired amount of information in the report may trigger a model to adjust baseline timeframes over which reports are to be generated. Finally, phrasing indicating a desired format in which the reports are to be delivered may trigger one or more changes to configuration parameters for the report generator 106 to update how the reports are generated and delivered.

In some cases, a user may indicate that the user does not wish to receive a particular report. However, the report the user does not want to receive can have a component that meets the baseline data 112 (e.g., a baseline threshold value). For example, a report that the user indicated as one they did not want to receive can have time series data 110 in the future that indicates a change in conditions, such as a sudden change in the time series data, directional change, or a trend developing in the time series data 110. Even though the user configured the subset of reports 116 to not include the report, the reporting service 104 can still provide the report to the user in instances of the time series data 110 meeting a baseline threshold value. For example, if the sudden change in time series data 110 exceeds a standard deviation in time series data or a new trend is developing in the time series data that meets a baseline threshold value, then a report can be generated by the report generator 106 using a corresponding template 108 and time series data 110. In such cases, the reporting service 104 can also provide a notification or message indicating the reason the report that was previously blocked is now included in the subset of reports the user receives.

The reporting service 104 via the report generator 106 can continue to monitor all reports and respective time series data similarly to provide reports that were previously not included in the initial subset of reports or the user indicated they did not want to receive. The reporting service 104 continues to monitor all of the time series data because time series data of the reports changes and future data may be of interest to the user, even though the current data may not be of interest to the user.

### Example Flow Diagram

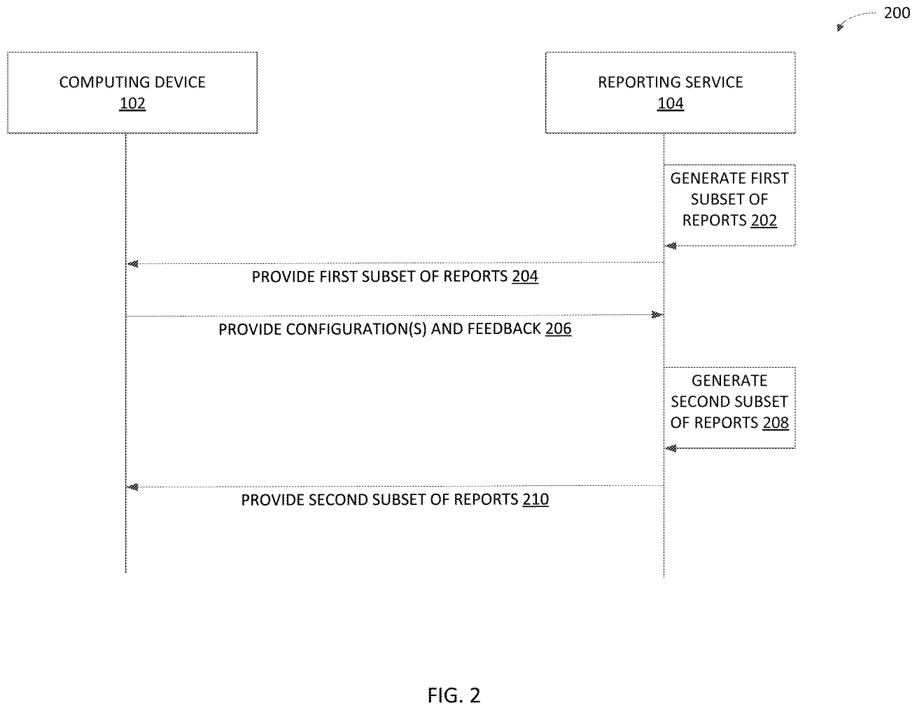

FIG. 2 depicts an example flow diagram 200 of the reporting service providing reports to a user. In the flow diagram 200, the reporting service 104 generates a first subset of reports 202. Each report in the first subset of reports is determined to meet a baseline threshold value from an initial set of reports based on the time series data and templates, as described in FIG. 1. The first subset of reports is provided 204 by the reporting service 104 to the computing device 102.

The reporting service 104 is part of a software program product. In some cases, an instance of the software application and reporting service 104 can be located locally on the computing device. In other cases, the reporting service 104 can be located remotely on a processing system (e.g., a server). In such cases, the computing device 102 and reporting service 104 can interact and transmit data via a web browser or other similar technology. The first subset of reports can be provided within the software application instance on the computing device, by email to an account associated with the user of the computing device, or available to the user accessing the software application via a web browser on the computing device 102.

Upon receiving the first subset of reports, the computing device 102 can display the reports to the user. The user, in turn, can input configurations and feedback corresponding to the first subset of reports to the computing device 102. The computing device 102 can provide the configurations and feedback 206 to the reporting service 104. The reporting service 104 can analyze the configurations and feedback to update how the reports are generated (e.g., update baseline data, templates, etc.). With the configurations and feedback, the reporting service 104 can generate a second subset of reports 208 based on the time series data and templates, as described in FIG. 1. The second set of reports are provided 210 by the reporting service to the computing device.

### Example Interactive User Interface

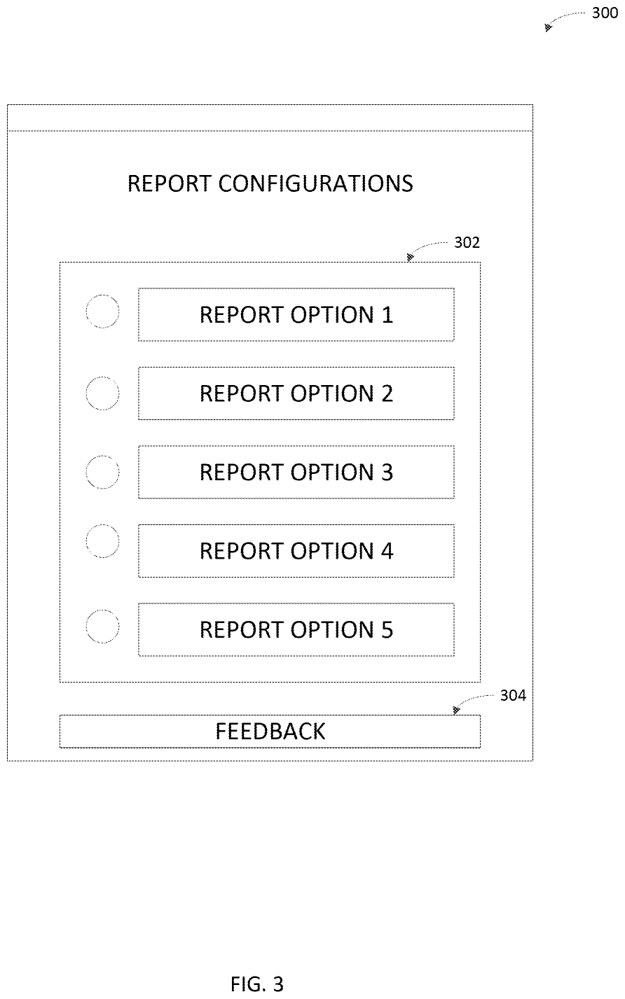

FIG. 3 depicts an example interactive user interface 300. In the example interactive user interface 300 is a set of report configurations 202 for the user to review and select. In 302, there are five report options listed (e.g., “Report Option 1”, “Report Option 2”, “Report Option 3”, “Report Option 4”, “Report Option 5”). The five report options are illustrative of the reports the user received from the reporting service. In some cases, a list of reports that the use received can be listed for the user to identify which report(s) the user would like to continue see. Alternatively, the list of reports can be displayed for a user to select which report(s) the user no longer wishes to receive.

In other cases, the user can indicate that the user no longer wants to receive a report from an option presented to the user within the report. In some cases, the report configurations can also include a place for a user to provide feedback 304. For example, the feedback 304 can be binary where the user can indicate whether the user finds the reports to be helpful. The feedback 304 can also be comments that the configuration module of the reporting service can analyze with natural language processing techniques.

### Example Method of Providing Personalized Reporting

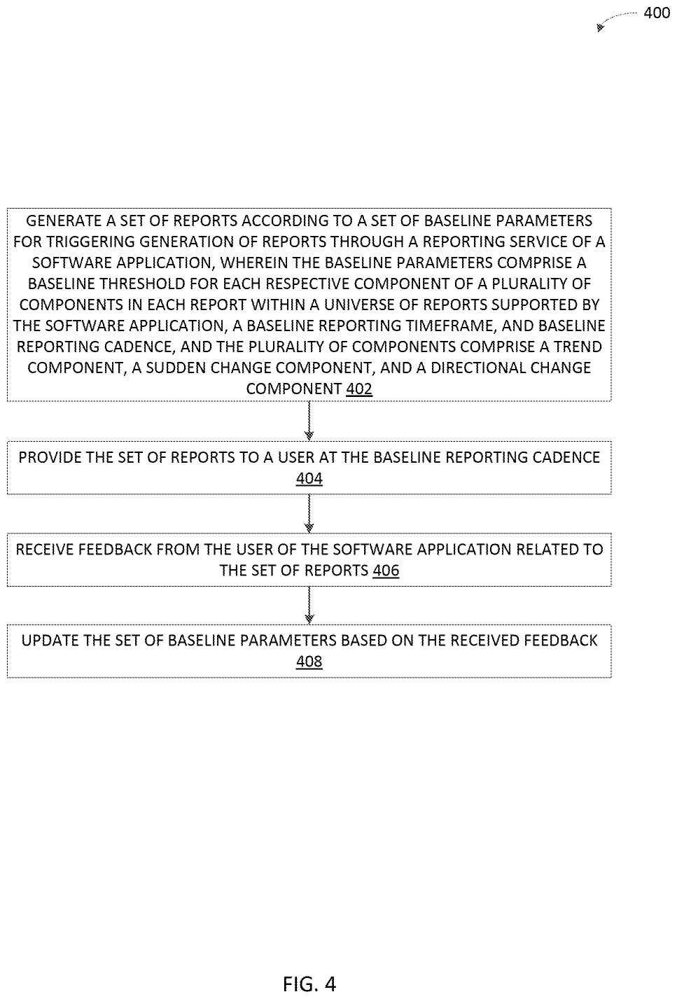

FIG. 4 depicts an example method 400 of providing personalized reporting by a reporting service of a software program product, as described in FIGS. 1 and 2.

At 402, a reporting service generates a set of reports according to a set of baseline parameters for triggering generation of reports through the reporting service of the software program product (or software application).

The baseline parameters generally include baseline threshold values, baseline reporting timeframes, and baseline reporting cadences. The baseline threshold values may generally be defined for each respective component of a plurality of components in each report within a universe of reports supported by the software application. The baseline reporting timeframe generally corresponds to a period of time over with time series data is aggregated in generating a report. The baseline reporting cadence generally corresponds to a frequency at which a report is generated. Generally, the baseline threshold value may be a value that a component must meet in order to provide the report to the user according to the baseline timeframe at a baseline reporting cadence.

In some cases, the baseline parameters can be set by an administrator related to the software program product. In other cases, the baseline parameters are determined by a trained model. For example, the baseline threshold values may be generated for each respective component in each report based on a set of historical reports generated by the reporting service of the software application. Baseline values for a trend component, a sudden change component, and a directional change component can be generated using various machine learning models trained on previously generated reports that are identified (or labeled) as corresponding to a component (e.g., trend, sudden change, or directional change) and user configurations and feedback. One example is a Seasonal and Trend (STL) decomposition algorithm for identifying the components. When utilizing the STL decomposition algorithm, the model generates numeric values related to determining standard deviations of the data points from the mean.

For example, the model can determine if there is any data in the time series data in which the trend component is more than X standard deviation from the mean, where X is a numeric value corresponding to the trend component. The X standard deviation can be generated for multiple time series data, and the trained model can be utilized to determine which standard deviation has the greatest predictive power with regards to the label and then that standard deviation can be used as a baseline. Other algorithms can be applied that can identify the components in the data. Additionally, the model can be trained based on previously collected data from users (e.g., configurations and feedback) indicating whether a report is valuable or not. Such previously collected data (or training data) is labeled for training the model. The model, in some cases, can generate the set of reports by aggregating a set of time series data and using the aggregated set of time series data as an input for generating each report in the set of reports.

In some cases, the trend component may include a minimum slope determined based on a regression analysis of data associated with the user in the software application. The minimum slope may correspond to a detection of a trend (e.g., an increase or decrease in the underlying data associated with the user). The sudden change component may correspond to a derivation from a mean calculated from the data associated with the user in the software application. Finally, the directional change component may include a distance between a minimum value and a maximum value in data associated with the user in the software application.

In some cases, the set of reports may be generated using a time series data algorithm. A time series algorithm can be used to determine whether components in each report meet at least one baseline threshold value defined for each report in the set of reports. The reports included in the set of reports may thus include reports for which at least at least one component meets a corresponding baseline threshold value and may exclude reports where no component meets a baseline threshold value.

At 404, the reporting service provides the set of reports to a user of the software application at the baseline reporting cadence.

At 406, the reporting service receives feedback from the user of the software application. The feedback received from the user of the software application may include configuration information identifying which reports the user wishes to receive in the future as well as feedback indicating a usefulness or relevance for each report. The feedback the reporting service receives may, in some aspects, include binary feedback regarding whether the user liked a report. The feedback the reporting service also can include comments that the reporting service can analyze with natural language processing techniques to extract information that identifies, for example, usefulness of a report or a periodicity for generating a report. The feedback received by the reporting service is generally used to update the subset of reports provided to the user as described at 412. The feedback may, in some cases, indicate that certain reports are to be omitted from future sets of reports generated by the reporting service.

At 408, the reporting service updates the baseline threshold for each component in the set of components, the baseline reporting timeframe, and the baseline reporting cadence based on the received feedback from the user. In one example, when the feedback includes an indication that the user would like to receive fewer reports of a particular type, the reporting service can adjust a baseline value to cause the reporting service to generate the report less frequently. For example, if the baseline threshold for a trend component is n standard deviations from the mean of the time series data, the baseline threshold may be adjusted upwards (e.g., to n+1 standard deviations from the mean of the time series data) based on an assumption that a report will be generated less frequently if the baseline threshold is further away from the mean of the time series data. In another example, where a baseline threshold for a trend component is a period of time in which data is range-bound between n standard deviations from the mean of the time series data, and the feedback includes an indication that the user would like to receive more reports of a particular type, the reporting service can adjust a baseline value to cause the reporting service to generate the report more frequently. For example, to do so, the baseline value may be adjusted upwards so that the trend is satisfied more frequently (e.g., based on an assumption that more data will be within a larger set of bounds than a smaller set of bounds). In still another example, different threshold values may be established for deviations upwards and deviations downwards from the mean. To generate more reports, these deviations may be decreased so that smaller deviations from the mean (which may be assumed to occur more often than larger deviations from the mean) are established; conversely, to generate fewer reports, the deviations may be increased so that larger deviations from the mean are established.

Subsequently, the reporting service can generate a second subset of reports from the first subset of reports corresponding to the updated baseline reporting timeframe by identifying each report in the set of reports that meets the updated baseline threshold, wherein the second subset of reports corresponds to a second period of time.

In some cases, in generating the second subset of reports, the reporting service can generate a report previously specified as a report for which generation is to be discontinued. However, the reporting system can generate the specified report based on the baseline values defined for this report and, if at least one component in the specified report meets a baseline threshold value, provide the specified report to the user in the second subset of reports. In providing the specified report to the user, the reporting service can also include information indicating a reason for including the report in the second set of reports to explain why the report was included in the second set of reports despite the user having previously discontinued generation of the report.

Note that FIG. 4 is just one example of a method, and other methods including fewer, additional, or alternative steps are possible consistent with this disclosure.

### Example Processing System

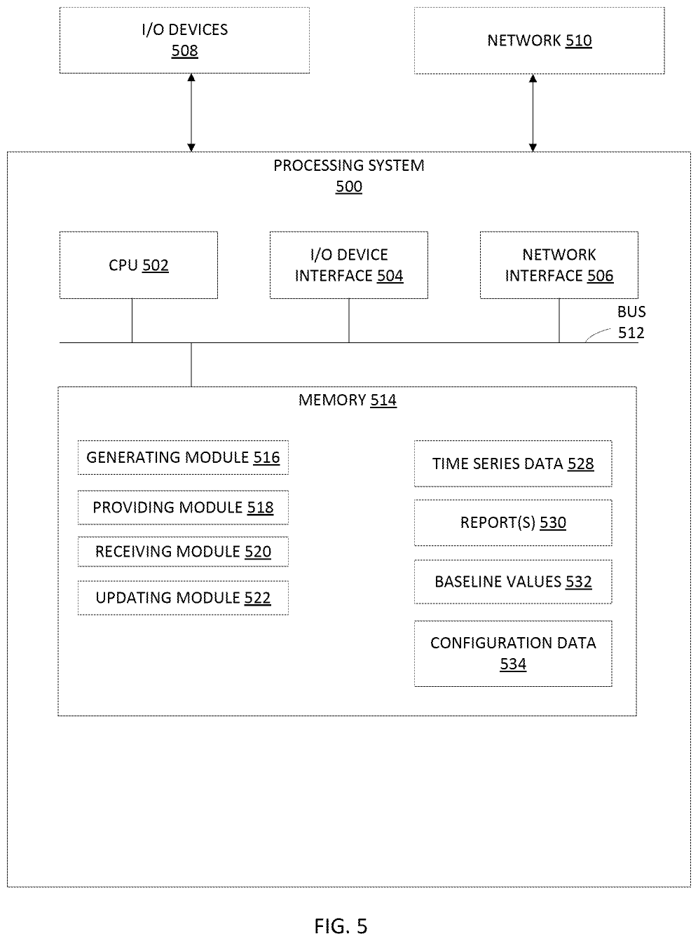

FIG. 5 depicts an example processing system 500 that may perform the methods described herein, for example, with respect to FIGS. 1, and 4. For example, the processing system 500 can be a physical server or a virtual server (e.g., cloud) server and is not limited to a single server that performs the methods described herein.

Processing system 500 includes a central processing unit (CPU) 502 connected to a data bus 512. CPU 502 is configured to process computer-executable instructions, e.g., stored in memory 514, and to cause the processing system 500 to perform methods described herein, for example, with respect to FIG. 4. CPU 502 is included to be representative of a single CPU, multiple CPUs, a single CPU having multiple processing cores, and other forms of processing architecture capable of executing computer-executable instructions.

Processing system 500 further includes input/output (I/O) device(s) 508 and interfaces 504, which allows processing system 500 to interface with input/output devices 508, such as, for example, keyboards, displays, mouse devices, pen input, and other devices that allow for interaction with processing system 500. Note that processing system 500 may connect with external I/O devices through physical and wireless connections (e.g., an external display device).

Processing system 500 further includes a network interface 506, which provides processing system 500 with access to external network 510 and thereby external computing devices.

Processing system 500 further includes memory 514, which in this example includes a generating module 516, a providing module 518, a receiving module 520, and an updating module 522.

Memory 514 further includes time series data 528, as described in FIGS. 1 and 4. For example, the time series data includes data corresponding to the software program product. The time series data is utilized by the reporting service to generate reports by aggregating the time series data and determining based on a trained model (e.g., an STL algorithm) that the time series data is a component that meets a baseline threshold value.

Memory 514 includes reports 530, as described in FIGS. 1 and 4. For example, the report is generated when the time series data meets a baseline threshold value and is generated and provided according to a baseline timeframe and cadence, respectively.

Memory 514 further includes baseline values 532, as described in FIGS. 1 and 4. For example, the baseline values include baseline threshold values, baseline timeframe, and baseline cadence.

Memory 514 further includes configuration data 534, as described in FIGS. 1 and 4. For example, the configuration data can include user selection of reports and feedback.

Note that while shown as a single memory 514 in FIG. 5 for simplicity, the various aspects stored in memory 514 may be stored in different physical memories, but all accessible by CPU 502 via internal data connections such as bus 512 or external connections, such as network interfaces 504. One of skill in the art will appreciate that one or more elements of processing system 500 may be located remotely and accessed via a network 506.

### Example Method of Personalizing Reporting

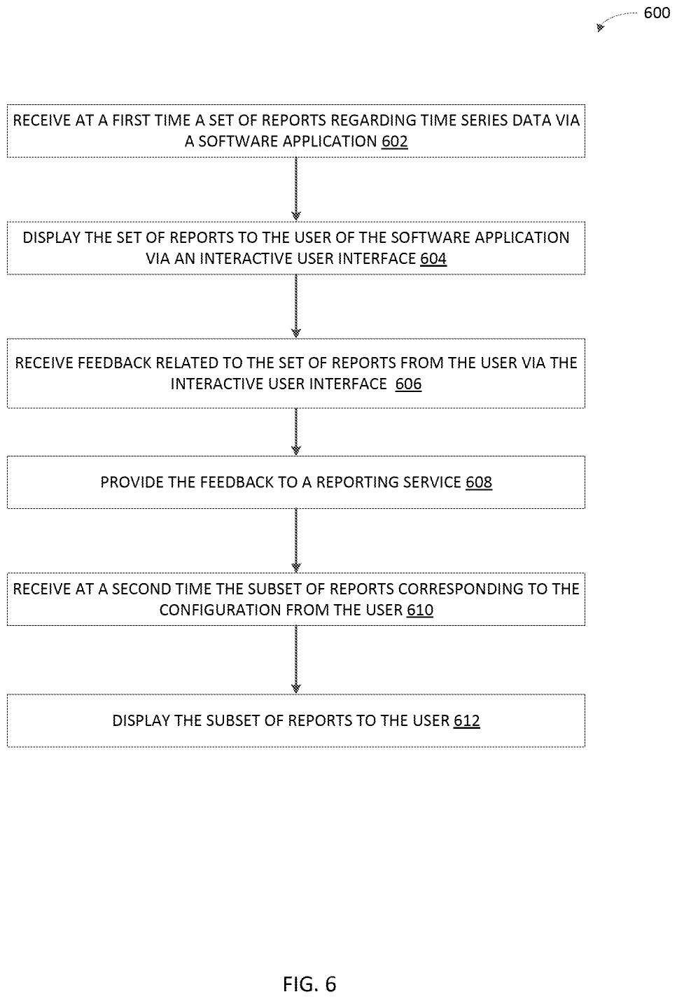

FIG. 6 depicts an example method 600 of personalizing reporting at a computing device by a user.

At 602, the computing device receives at a first time a set of reports regarding time series data via a software application.

In some cases, the computing device includes a local instance of the software application. In other cases, the computing device can access the software application located on a remote server, for example, via a web browser.

Additionally, the computing device can receive a set of reports for training purposes in order to generate configuration and feedback data to train the machine learning model in the report generator of the reporting service. In such cases, the set of reports received by the computing device can include all of the reports the software application is capable of generating to determine baseline threshold values of reports.

At 604, the computing device displays the set of reports to the user of the software application via an interactive user interface.

At 606, the computing device receives, via the interactive user interface, feedback from the user of the software application related to the set of reports. The feedback information may, in some cases, include information indicating a selection of reports from the subset of reports (e.g., information identifying which reports to be included or excluded in future sets of reports generated by the software application). The feedback may also include information identifying user opinions with respect to the reports in the set of reports, which may include binary feedback (e.g., like or dislike selected in regards to the report) or user comments regarding the reports from which usable information for modifying the parameters against which future reports are generated can be extracted via sentiment analysis or other natural language processing techniques.

At 608, the computing device provides the feedback to the reporting service. In some cases, the computing device can include a local instance of the software application and reporting service. In other cases, the reporting service of the software application can be remotely located (e.g., on a server) and the computing device can provide the configuration and/or feedback to the reporting service via a web browser. Generally, in providing feedback, the computing device can trigger an updating process at the software application to update the baseline parameters used to trigger the generation of reports through a reporting service of the software application.

At 610, the computing device receives at a second time the subset of reports corresponding to the feedback from the user.

At 612, the computing device displays the subset of reports to the user.

Note that FIG. 6 is just one example of a method, and other methods including fewer, additional, or alternative steps are possible consistent with this disclosure.

### Example Computing Device

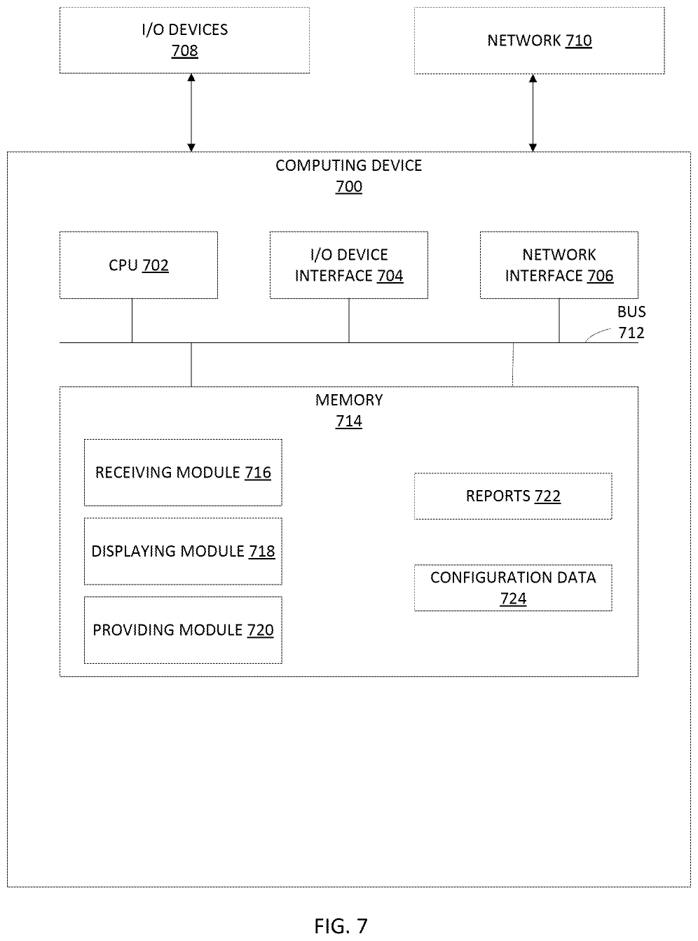

FIG. 7 depicts an example computing device 700 that may perform the methods described herein, for example, with respect to FIGS. 1 and 6. For example, the computing device 700 can be a tablet, smartphone, laptop computer, and other devices with similar capabilities and is not limited to a single computing device that performs the methods described herein.

Computing device 700 includes a central processing unit (CPU) 702 connected to a data bus 712. CPU 702 is configured to process computer-executable instructions, e.g., stored in memory 714, and to cause the computing device 700 to perform methods described herein, for example, with respect to FIG. 6. CPU 702 is included to be representative of a single CPU, multiple CPUs, a single CPU having multiple processing cores, and other forms of processing architecture capable of executing computer-executable instructions.

Computing device 700 further includes input/output (I/O) device(s) 708 and interfaces 704, which allows computing device 700 to interface with input/output devices 708, such as, for example, keyboards, displays, mouse devices, pen input, and other devices that allow for interaction with computing device 700. Note that computing device 700 may connect with external I/O devices through physical and wireless connections (e.g., an external display device).

Computing device 700 further includes a network interface 706, which provides computing device 700 with access to external network 710 and thereby external computing devices.

Computing device 700 further includes memory 714, which in this example includes a receiving module 716, displaying module 718, and providing module 720.

Memory 714 further includes reports 722, as described in FIGS. 1 and 6.

Memory 714 further includes configuration data 724, as described in FIGS. 1 and 6, which includes configurations from users regarding selection of reports in the subset of reports provided to the computing device 700 and feedback data from the users regarding the report.

Note that while shown as a single memory 714 in FIG. 7 for simplicity, the various aspects stored in memory 714 may be stored in different physical memories, but all accessible by CPU 702 via internal data connections such as bus 712 or external connections, such as network interfaces 704. One of skill in the art will appreciate that one or more elements of computing device 700 may be located remotely and accessed via a network 706.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
generating a set of reports according to a set of baseline parameters for triggering generation of reports through a reporting service of a software application, wherein:
the baseline parameters comprise a baseline threshold for each respective component of a plurality of components in each report within a universe of reports supported by the software application, a baseline reporting timeframe, and a baseline reporting cadence, and
the plurality of components comprise a trend component, a sudden change component, and a directional change component;
providing the set of reports to a user at the baseline reporting cadence;
receiving feedback from the user of the software application related to the set of reports; and
updating the set of baseline parameters based on the received feedback.

2. The method of claim 1, further comprising generating the baseline threshold for each respective component in each report based on a set of historical reports generated by the software application.

3. The method of claim 2, wherein generating the baseline threshold for each respective component in each report comprises identifying values for the trend component, the sudden change component, and the directional change component based on a seasonal and trend (STL) decomposition of the set of historical reports.

4. The method of claim 1, wherein the trend component comprises a minimum slope in a regression analysis of data associated with the user in the software application corresponding to detection of a trend in the data associated with the user in the software application.

5. The method of claim 1, wherein the sudden change component comprises a deviation from a mean calculated from data associated with the user in the software application.

6. The method of claim 1, wherein the directional change component comprises a distance between a minimum value and a maximum value in data associated with the user in the software application.

7. The method of claim 1, wherein the set of reports is generated using a time series data algorithm to determine whether each component of each report in the set of reports meets at least one baseline threshold defined for each report in the set of reports.

8. The method of claim 1, wherein the feedback comprises a user configuration of reports to be omitted from future reports generated by the reporting service.

9. The method of claim 1, wherein the set of reports is generated by a machine learning model.

10. The method of claim 9, wherein generating the set of reports by the machine learning model includes aggregating a set of time series data as an input for generating each report in the set of reports.

11. The method of claim 1, wherein the feedback comprises instructions to discontinue generation of a specified report.

12. The method of claim 11, further comprising:
receiving time series data covering a specified time period, wherein the time series data meets at least one baseline threshold associated with the specified report;
generating the specified report corresponding to the baseline threshold; and
providing the specified report in a second set of reports corresponding to the specified time period to the user.

13. The method of claim 12, wherein the second set of reports includes information indicating a reason for including the report in the second set of reports.

14. The method of claim 1, further comprising generating a second set of reports for time series data for the user of the software application over a specified period of time based on the updated set of baseline parameters.

15. The method of claim 1, wherein:
the received feedback comprises natural language feedback, and
updating the set of baseline parameters comprises:
extracting, from the received feedback based on natural language processing techniques, information indicative of one or more of a usefulness of each report within the set of reports or a periodicity in which each report is to be generated; and
adjusting the set of baseline parameters based on the extracted information.

16. A system, comprising:
a memory having executable instructions stored thereon; and
a processor configured to execute the executable instructions in order to cause the system to:
generating a set of reports according to a set of baseline parameters for triggering generation of reports through a reporting service of a software application, wherein:
the baseline parameters comprise a baseline threshold for each respective component of a plurality of components in each report within a universe of reports supported by the software application, a baseline reporting timeframe, and a baseline reporting cadence, and
the plurality of components comprise a trend component, a sudden change component, and a directional change component;
providing the set of reports to a user at the baseline reporting cadence;
receiving feedback from the user of the software application related to the set of reports; and
updating the set of baseline parameters based on the received feedback.

17. The system of claim 16, wherein the processor is further configured to cause the system to generate the baseline threshold for each respective component in each report based on a set of historical reports generated by the software application.

18. The system of claim 16, wherein:
the set of reports is generated by a machine learning model; and
in order to generate the set of reports by the machine learning model, the processor is configured to cause the system to aggregate a set of time series data as an input for generating each report in the set of reports.

19. The system of claim 16, wherein:
the feedback comprises instructions to discontinue generation of a specified report; and
the processor is further configured to cause the system to:
receive time series data covering a specified time period, wherein the time series data meets at least one baseline threshold associated with the specified report;
generate the specified report corresponding to the baseline threshold; and
provide the specified report in a second set of reports corresponding to the specified time period to the user.

20. A method, comprising:
generating a set of reports according to a set of baseline parameters for triggering generation of reports through a reporting service of a software application, wherein:
the baseline parameters comprise a baseline threshold for each respective component of a plurality of components in each report within a universe of reports supported by the software application, a baseline reporting timeframe, and a baseline reporting cadence, and
the plurality of components comprise a trend component, a sudden change component, and a directional change component;
providing the set of reports to a user at the baseline reporting cadence;
receiving feedback from the user of the software application related to the set of reports;
updating the set of baseline parameters based on the received feedback; and
generating a second set of reports for time series data for the user of the software application over a specified period of time based on the updated set of baseline parameters.
